(19) United States
(12) Patent Application Publication
(10) Pub. No.: US 2026/0333213 A1
(43) Pub. Date: Oct. 22, 2026

(54) ACCESS CONTROL FOR ENERGY SAVING MODE

(71) Applicant: Nokia Technologies Oy, Espoo (FI)

(72) Inventors: Daniela LASELVA, Aalborg (DK); Chunli WU, Beijing (CN); Tao TAO, Shanghai (CN); Jarkko Tuomo KOSKELA, Oulu (FI)

(21) Appl. No.: 19/115,654

(22) PCT Filed: Sep. 29, 2022
(86) PCT No.: PCT/CN2022/122837

§ 371 Date: Mar. 26, 2025

(51) Int. Cl. H04W 52/02; H04W 48/02

(52) U.S. Cl. CPC H04W 52/0206; H04W 48/02

(57) ABSTRACT

Example embodiments of the present disclosure relate to access control for energy saving mode. A first device receiving, from a second device, at least one barring configuration corresponding to at least one energy saving mode of the second device. The first device receives, from the second device, a first mode indication that the second device operates in a first energy saving mode of the at least one energy saving mode. The first device performs a first operation associated with an access to the second device based on a first barring configuration, of the at least one barring configuration, corresponding to the first energy saving mode.

### FIELD

Various example embodiments of the present disclosure generally relate to the field of telecommunication and in particular, to methods, devices, apparatuses and computer readable storage medium for access control for energy saving mode.

### BACKGROUND

Reducing the energy consumption of mobile networks, and particularly of the radio access network (RAN), which consumes the largest part of the total energy consumption in the network, has gained significant attention. Accordingly, means for obtaining network energy saving in the fifth generation (5G) communication system have been proposed. Studies on the network energy saving are mainly focused on the radio access network and aim at identifying adaptation techniques of transmissions and/or receptions in time, frequency, spatial, and power domains, with potential support and/or feedback from user equipment (UE), potential UE assistance information, and information exchange and/or coordination over network interfaces.

### SUMMARY

In a first aspect of the present disclosure, there is provided a first device. The first device comprises at least one processor; and at least one memory storing instructions that, when executed by the at least one processor, cause the first device at least to perform: receiving, from a second device, at least one barring configuration corresponding to at least one energy saving mode of the second device; receiving, from the second device, a first mode indication that the second device operates in a first energy saving mode of the at least one energy saving mode; and performing a first operation associated with an access to the second device based on a first barring configuration, of the at least one barring configuration, corresponding to the first energy saving mode.

In a second aspect of the present disclosure, there is provided a second device. The second device comprises at least one processor; and at least one memory storing instructions that, when executed by the at least one processor, cause the second device at least to perform: transmitting, to a first device, at least one barring configuration corresponding to at least one energy saving mode of the second device; determining whether the second device operates in an energy saving mode of the at least one energy saving mode; and in accordance with a determination that the second device operates in a first energy saving mode of the at least one energy saving mode, transmitting to the first device a first mode indication that the second device operates in the first energy saving mode.

In a third aspect of the present disclosure, there is provided a method. The method comprises: receiving, at a first device from a second device, at least one barring configuration corresponding to at least one energy saving mode of the second device; receiving, from the second device, a first mode indication that the second device operates in a first energy saving mode of the at least one energy saving mode; and performing a first operation associated with an access to the second device based on a first barring configuration, of the at least one barring configuration, corresponding to the first energy saving mode.

In a fourth aspect of the present disclosure, there is provided a method. The method comprises: transmitting, from a second device to a first device, at least one barring configuration corresponding to at least one energy saving mode of the second device; determining whether the second device operates in an energy saving mode of the at least one energy saving mode; and in accordance with a determination that the second device operates in a first energy saving mode of the at least one energy saving mode, transmitting to the first device a first mode indication that the second device operates in the first energy saving mode.

In a fifth aspect of the present disclosure, there is provided a first apparatus. The first apparatus comprises means for receiving, from a second apparatus, at least one barring configuration corresponding to at least one energy saving mode of the second apparatus; means for receiving, from the second apparatus, a first mode indication that the second apparatus operates in a first energy saving mode of the at least one energy saving mode; and means for performing a first operation associated with an access to the second apparatus based on a first barring configuration, of the at least one barring configuration, corresponding to the first energy saving mode.

In a sixth aspect of the present disclosure, there is provided a second apparatus. The second apparatus comprises means for transmitting, to a first apparatus, at least one barring configuration corresponding to at least one energy saving mode of the second apparatus; means for determining whether the second apparatus operates in an energy saving mode of the at least one energy saving mode; and means for in accordance with a determination that the second apparatus operates in a first energy saving mode of the at least one energy saving mode, transmitting to the first apparatus a first mode indication that the second apparatus operates in the first energy saving mode.

In a seventh aspect of the present disclosure, there is provided a computer readable medium. The computer readable medium comprises instructions stored thereon for causing an apparatus to perform at least the method according to the first aspect.

In an eighth aspect of the present disclosure, there is provided a computer readable medium. The computer readable medium comprises instructions stored thereon for causing an apparatus to perform at least the method according to the second aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling chart for access control according to some example embodiments of the present disclosure;

FIG. 3 illustrates a flowchart of a method implemented at a first device according to some example embodiments of the present disclosure;

FIG. 4 illustrates a flowchart of a method implemented at a second device according to some example embodiments of the present disclosure;

FIG. 5 illustrates a simplified block diagram of a device that is suitable for implementing example embodiments of the present disclosure; and

FIG. 6 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future systems such as sixth generation (6G). Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

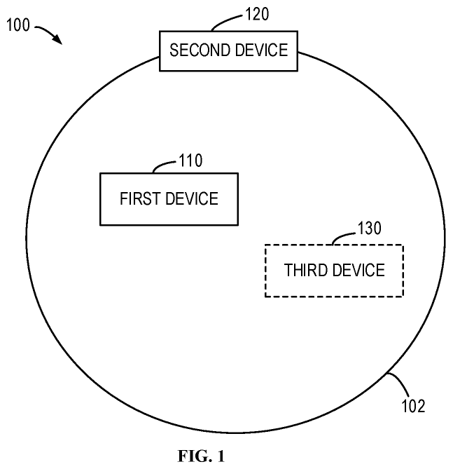

FIG. 1 illustrates an example communication environment 100 in which example embodiments of the present disclosure can be implemented. In the communication environment 100, a plurality of communication devices, including a first device 110 and a second device 120, can communicate with each other.

In some example embodiments, the first device 110 may include a terminal device and the second device 120 may include a network device serving the terminal device. The serving area of the second device 120 may be called a cell 102.

It is to be understood that the number of devices and their connections shown in FIG. 1 are only for the purpose of illustration without suggesting any limitation. The communication environment 100 may include any suitable number of devices configured to implementing example embodiments of the present disclosure.

In the following, for the purpose of illustration, some example embodiments are described with the first device 110 operating as a terminal device and the second device 120 operating as a network device. However, in some example embodiments, operations described in connection with a terminal device may be implemented at a network device or other device, and operations described in connection with a network device may be implemented at a terminal device or other device.

In some example embodiments, if the first device 110 is a terminal device and the second device 120 is a network device, a link from the second device 120 to the first device 110 is referred to as a downlink (DL), while a link from the first device 110 to the second device 120 is referred to as an uplink (UL). In DL, the second device 120 is a transmitting (TX) device (or a transmitter) and the first device 110 is a receiving (RX) device (or a receiver). In UL, the first device 110 is a TX device (or a transmitter) and the second device 120 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

The second device 120 can sometimes operate in an energy saving(ES) mode. For example, if the second device 120 is a network device, the second device 120 may sometimes operate in a network energy saving (NES) mode. In the ES mode, some of its hardware components may be switched off or kept in a sleep state to obtain energy reduction. As a result, the capability of the second device 120 to provide services to other devices (for example, including the first device 110) may be temporarily reduced until the ES mode is exited. Energy consumption is required if the second device 120 exits the ES mode and revert to the normal performance level.

The ES mode may be achieved using any suitable means. For example, infrequent Synchronization Signal Block (SSB) transmission, e.g., SSB periodicity of 160 ms, may be used in empty or low load situation in 5G non standalone (NSA) deployments. As another example, micro discontinuous transmission (DTX), which consists in shutting down the power amplifier on a per OFDM symbol basis, in symbols that do not carry data nor signaling, may be used. In a further example, further components of the second device 120 could be shut down based on network architecture and capability. For example, transmit antennas as in massive Multiple-Input Multiple-Output (mMIMO) muting, and baseband circuity may be shut down. In still a further example, the ES mode may be achieved by means of cell shutdown, which allows to switch off one or more cells (e.g. at a given frequency layer), and hence to switch off most of the hardware components of the corresponding Radio Unit and/or RAN site.

The second device 120 operates in one of a non ES mode and at least one ES mode. In some example embodiments, the second device 120 may operate in one of an ES mode and the non-ES mode. In some example embodiments, the second device 120 may operate in one of the non-ES mode and a plurality of ES modes. Examples of the ES mode may include, but not limited to, a dormant cell, a dormant base station (e.g., a dormant gNB), a cell with less or no transmission of SSB (which is also referred to an SSB-less cell), a cell with less or no transmission of system information block (SIB) 1 (which is also referred to as an SIB1-less cell), a cell with relaxed SSB periodicity, or multiple levels with different SSB periodicities, a cell with one or more dormant beams, etc.

In some example embodiments, different ES modes may have different levels of energy saving and thus may be referred to as ES modes of different levels. As a result, a switch from an ES mode of higher level to the non-ES mode requires more energy consumption than a switch from an ES mode of lower level to the non-ES mode. For example, in the ES mode of a dormant cell or a dormant gNB, the cell or the gNB is deactivated. While, in the ES mode with a relaxed SSB periodicity or one or more dormant beam, certain hardware components are already switched on although possibly in a reduced fashion. Energy consumption for switching from the ES mode of the dormant cell or the dormant gNB to the non-ES mode is higher than energy consumption for switching from the ES mode with relaxed SSB periodicity or one or more dormant beam to the non-ES mode.

It is to be understood that the above examples of ES mode are given for the purpose of illustration without any limitation to the protection scope. In the example embodiments of the present disclosure, there may be any suitable type and number of ES modes. The ES mode of the second device 120 may be also referred to as an inactive state or sleep state.

The first device 110 can support the ES mode of the second device 120 and thus is also referred to as an ES supporting device. In some embodiments, the communication environment 100 may further comprise a third device 130 of a different type from the first device 110. The third device 130 cannot support the ES mode of the second device 120 and may be referred to as a legacy device.

Take the gNB as an example. Whenever the gNB or one of the network entities under its control (such as a cell, a DU, a CU) operates in an NES mode such as a dormant state, this entails that some of the hardware components of the gNB are switched off or kept in a sleep mode to obtain network energy reduction. As a result, the capability of the gNB to provide services to the UEs may be temporarily reduced until the NES mode is exited. Accordingly, there can be a trade-off between the energy to be saved and performance to be provided, which may depend on the load level and subscriber types. For example, the provided performance during the NES mode (e.g. in terms of bit rate, latency, number of served UEs, amount of data served, etc.) may be limited or degraded. For another example, data transfer or initial access can be inhibited altogether for some UEs. To enable increased performance or revert to the normal performance level, the gNB may want to exit the NES mode, however this comes at the price of an increased energy consumption.

Therefore, it is desired to address how the gNB can control such trade-off between energy and performance, and particularly how to control the new service requests from UEs in the initial access whenever the gNB is operating in an energy saving mode. In other words, the gNB needs to control if and which UEs are allowed to initiate access to the gNB.

In a solution, the gNB can configure limitations to the initial access using the Unified Access control (UAC) framework. The UAC framework is however defined to mitigate network congestion and does not account for the NES mode. Also, the UAC information is transmitted in system information (SI), and thus requires SI modification for any changes to be made to the access barring. This implies that in the UAC framework, the gNB cannot adjust the barring information very dynamically, and that every adjustment requires SI re-acquisition. Moreover, as the NES mode of the gNB could change frequently without upper layer signaling (e.g., radio resource control, RRC, signalling), a slow update of barring information may become difficult to manage.

According to some example embodiments of the present disclosure, there is provided a solution for access control for energy saving mode. In this solution, a first device is configured with at least one barring configuration corresponding to at least one ES mode of a second device. A barring configuration is valid or active for an ES mode of the second device. If the first device is indicated that the second device operates in a specific ES mode, the first device performs an operation associated with an access to the second device based on a specific barring configuration corresponding to the specific ES mode.

In the example embodiments of the present disclosure, upon change of the ES mode of the second device, the first device is implicitly triggered to apply the barring configuration corresponding to the given ES mode to access the second device. This means that the access of the first device to the second device depends on the actual ES mode of the second device.

In this way, the second device (for example, the gNB) can flexibly control access of other devices (for example, the UEs) based on the current ES mode of the second device. Moreover, changing the barring configuration can be achieved without an update of SIB, which is required by the UAC framework, and thus can be achieved without the need for the first device to re-acquire SI upon change of the ES mode.

Example embodiments of the present disclosure will be described in detail below with reference to the accompanying drawings.

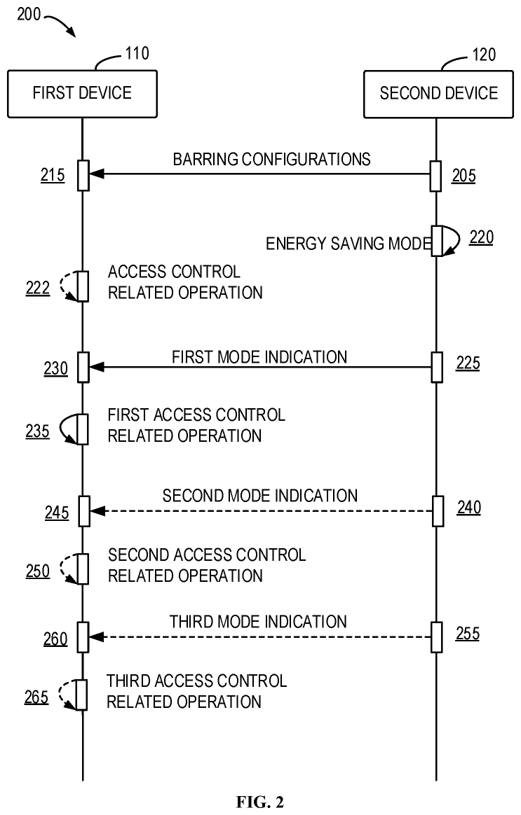

FIG. 2, which shows a signaling chart 200 for access control according to some example embodiments of the present disclosure. As shown in FIG. 2, the signaling chart 200 involves a first device 110 and a second device 120. For the purpose of discussion, reference is made to FIG. 1 to describe the signaling chart 200. Although one first device 110 is illustrated in FIG. 2, it would be appreciated that there may be a plurality of first device performing similar operations as described with respect to the first device 110 below.

The second device 120 transmits 205, to the first device 110, at least one barring configuration corresponding to at least one ES mode of the second device 120. Each ES mode may have one or more corresponding barring configurations. Or, more than one barring configurations may be corresponding to the same ES mode. In other words, the first device 120 is configured with different barring configurations per ES mode. In this way, flexibility can be achieved to indicate specific barring for an ES mode as compared to barring for congestion. In the following, a barring configuration corresponding to an ES mode of the second device 120 or configured for the purpose of energy saving is also referred to as an “ES barring configuration” or “ES barring information”.

In some example embodiments, the at least one ES barring configurations may comprise a set of access barring parameters corresponding to an ES mode of the second device 120. For example, each ES mode may have a corresponding set of access barring parameters. The sets of access barring parameters for different ES modes may be different or the same. In the following, the access barring parameters may also referred to as access barring information.

A set of access barring parameters corresponding to a specific ES mode is used to control access requests from the first device 110 when the second device 120 operates in the specific ES mode. The access barring parameters corresponding to an ES mode may include a barring indicator for the ES mode, which indicates whether an access attempt to the second device 120 is allowed when the second device 120 operates in the ES mode. Alternatively, or in addition, the access barring parameters corresponding to the ES mode may include a barring factor for the ES mode, which indicates a probability that an access request from the first device 110 can be allowed when the second device 120 operates in the ES mode.

Alternatively, or in addition, the access barring parameters may include a barring time for the ES mode, which defines the minimum time interval before another access attempt can be performed after an access attempt was barred when the second device 120 operates in the ES mode. Alternatively, or in addition, the access barring parameters may include an indication of a barring timer for the ES mode. When an access attempt by the first device 110 is barred, an instance of the barring time may be started. The barring timer may include, but not limited to, T390 and T302. Further, in some example embodiments, the barring timer may be configured to depend on an access category (AC) of the first device 110. For example, the barring timer may depend on whether the first device 110 is configured with a delay tolerant service or not.

Alternatively, or in addition, in some example embodiments, the at least one ES barring configuration may comprise a cell barring indication corresponding to an ES mode of the second device 120. The cell barring indication indicates whether a cell served by the second device 120 is barred for the first device when the second device 120 operates in the ES mode. In other words, the cell barring indication is used to control whether the first device 110 can camp the cell served by the second device 120 when the second device 120 operates in the ES mode.

In some example embodiments, the second device 120 may additionally transmit, to the first device 110, a barring configuration corresponding to a non-ES mode of the second device 120, which is also referred to as a non-ES barring configuration. The non-ES barring configuration may be transmitted as a part of or separately from the at least one ES barring configurations. The non-ES barring configuration may include a set of access barring parameters for the non-ES mode. Similar to the ES barring information, the set of access barring parameters for the non-ES mode may include a barring indicator for the non-ES mode, a barring factor for the non-ES mode, a barring time for the non-ES mode, or a barring timer for the non-ES mode. Alternatively, or in addition, the non-ES barring configuration may include a cell barring indication of whether a cell is barred when the second device 120 operates in the non-ES mode.

In some example embodiments, in addition to the at least one ES barring information, the second device 120 may transmit, to the first device 110, barring configurations for congestion, which are also referred as legacy barring configurations. Similar to the ES barring configurations, the legacy barring configurations may include access barring parameters and/or a cell barring indication.

In some example embodiments, the at least one ES barring configuration may be determined such that a more limiting access is configured for an ES mode of a higher level (for example, with a dormant cell, or dormant gNB) as compared to another ES mode of a lower level (for example, a cell which operates with a relaxed SSB periodicity or a dormant beam). For example, a lower barring factor and/or a larger barring time may be configured for the ES mode of the higher level as compared to the other ES mode of the lower level. For another example, a cell may be barred for the ES mode of the higher level but may not be barred for the other ES mode of the lower level. In this way, frequently switching on of the second device 120, which requires high energy consumption, can be avoided.

Example content of the at least one ES barring configuration is described above. The at least one ES barring configuration can be transmitted in any suitable signalling. In some example embodiments, the second device 120 may broadcast at least a portion of the at least one ES barring configuration in an information block. In an example, one or more set of access barring parameters for the ES modes may be transmitted in SIB. For example, the SIB may include an information element “uac-Barringinfo NES” for carrying the access barring parameters corresponding to the ES modes. In another example, the cell barring indications corresponding to the ES modes may be transmitted in a Master Information Block (MIB).

In some example embodiments, the second device 120 may transmit the at least one ES barring configuration in a message dedicated to the first device 110. In such example embodiments, the ES barring configuration can be device-specific, such as UE-specific. For example, the at least one ES barring configuration may be transmitted in an RRCReject message to the first device 110. In this way, when the first device 110 returns to the cell of the second device 120, the ES barring configuration in the RRCReject message can be applied by the first device 110.

The first device 110 receives 215 the at least one ES barring configuration from the second device 120. In some example embodiments, the first device 110 may further receive the non-ES barring configuration from the second device 120. In some example embodiments, the first device 110 may additionally receive the legacy barring configuration from the second device 120.

When the second device 120 does not indicate any ES mode or the second device 120 indicates that it operates in the non-ES mode, the first device 110 may perform 222 an operation associated with an access to the second device 120 based on a barring configuration for the non-ES mode. For purpose of illustration, an operation associated with an access to the second device 120 is also referred to as access control related operation. The access control related operation may comprise an access barring check for an access attempt to the second device 120. Alternatively, or in addition, the access control related operation may comprise determining whether a cell of the second device 120 can be camped.

This barring configuration used by the first device 110 when the second device 120 is not operating in an ES mode may be the non-ES barring configuration or the legacy barring configuration. For example, the first device 110 may apply a cell barring indication of the legacy barring configuration to determine whether to camp on a cell of the second device 120. For another example, the first device 110 may apply access barring parameters of the legacy barring configuration to perform an access barring check for the access attempt to the second device 120.

Continuing with the chart 200, the second device 120 determines 220 whether it operates in or enters into an ES mode. If the second device 120 operates in or enters into a first ES mode, the second device 120 transmits 225, to the first device 110, a first mode indication that the second device 120 operates in the first ES mode.

The first mode indication and optional other mode indication (which collectively or individually referred to as “mode indication”) may be transmitted via any suitable layer. In some example embodiments, the mode indication may be transmitted via the physical (PHY) layer or the media access control (MAC) layer. The mode indication can indicate implicitly or explicitly the specific ES mode in which the second device 120 operates, and any change of such an ES mode.

The first device 110 receives 230 the first mode indication from the second device 120. In response to the first mode indication, the first device 110 may determine a first barring configuration corresponding to the first ES mode from the at least one ES barring configuration. Then, the first device 110 performs 235 a first access control related operation based on the first barring configuration.

In some example embodiments, the first device 110 may skip applying a further barring configuration configured for a device not supporting the ES mode of the second device 120. For example, the further barring information may be the legacy barring information for the legacy device. For example, the first device 110 will not apply legacy access barring parameters. While the third device 130 as a legacy device still applies the legacy barring configuration. In some example embodiments, skipping applying the further barring configuration is defined in a technical specification. In such example embodiments, no indication from the second device 120 is needed. Alternatively, in some example embodiments, skipping applying the further barring configuration may be based on receiving the at least one ES barring configuration.

In some example embodiments, the first device 110 may receive from the second device 120 an indication to skip applying the further barring configuration. This indication may be transmitted by the second device 120 along with the at least one ES barring configuration, such as in the SIB or MIB. In response to the indication, the first device 110 may skip applying the further barring configuration.

The first access control related operation performed at 235 may include determination of whether to camp on a cell and/or an access barring check. In some example embodiment, the first barring configuration may include a cell barring indication for the first ES mode, which indicates whether a cell served by the second device 120 is barred when the second device 120 operates in the first ES mode. Accordingly, the first device 110 determines whether the cell is barred based on the cell barring indication. If the cell is not barred, the first device 110 may camp on the cell for a subsequent access to the second device 120. If the cell is barred, the first device 110 will not camp on the cell.

In such example embodiments, the cell barring indication can be given per ES mode. In this way, if some specific NES mode is applied in a cell, devices (e.g., UEs) can be prevented from camping on that cell. For example, the gNB can set the legacy indication “cellBarred” as barred thus preventing legacy UEs camping on a NES cell, but UEs supporting NES would be allowed to skip applying (ignore) such “cellBarred” indication and be allowed to camp on the cell if some specific NES mode is applied.

Alternatively, or in addition, in some example embodiments, the first barring configuration may include a set of access barring parameters corresponding to the first ES mode. As mentioned above, the set of access barring parameters corresponding to the first ES mode may include a barring indicator for the first ES mode, a barring factor for the first ES mode, a barring time for the first ES mode, and/or an indication of a barring timer for the first ES mode.

Based on the set of access barring parameters corresponding to the first ES mode, the first device 110 may perform an access barring check for an access attempt to the second device 120. For example, the first device 110 may first determine whether the access attempt is allowed based on the barring indicator. If the access attempt is allowed, the first device 110 may generate a random number between 0 and 1. If the random number is less than the value of the barring factor, the access attempt is permitted. Otherwise, the access attempt is barred. If the access attempt is barred, the first device 110 may wait for the barring time to perform an access barring check for another access attempt to the second device 120.

In some example embodiments, the first device 110 may be configured with an association between the first ES mode and one or more access categories (ACs). For example, the first device 110 may receive first information indicating the association from the second device 120. Then, the first device 110 may perform the access barring check for the access attempt associated with the one or more ACs based on the set of access barring parameters corresponding to the first ES mode.

Alternatively, or in addition, in some example embodiments, the first device 110 may be configured with an association between the first ES mode and one or more access identities (AIs). For example, the first device 110 may receive second information indicating the association from the second device 120. Then, the first device 110 may perform the access barring check for the access attempt associated with the one or more AIs based on the set of access barring parameters corresponding to the first ES mode.

In some example embodiments, the access barring information per ES mode of the second device 120 may be beam-specific. Accordingly, to determine the set of access barring parameter to be applied, the first device 110 may further consider a beam via which the first device 110 and the second device 120 communicate. In this way, it allows to apply different access barring parameters to different beams. For example, if the ES mode differs across the SSB beams, this allows to apply different access barring parameters to the different SSB beams accordingly. In such example embodiments, the flexibility of controlling UEs access the network can be further improved.

Alternatively, or in addition, in some example embodiments, the access barring information per ES mode of the second device 120 may be Public Land Mobile Network (PLMN)-specific. Accordingly, to determine the set of access barring parameter to be applied, the first device 110 may further consider the PLMN serving the first device 110. In such example embodiments, the flexibility of controlling UEs access the network can be further improved.

Continuing with the chart 200, in some example embodiments, if the second device 120 enters into a second ES mode, the second device 120 may transmit 240 to the first device 110 a second mode indication that the second device 120 operates in the second ES mode. For example, if a switch from the first ES mode to the second ES mode occurs, the second device 120 may indicate the first device 110 of the switch.

The first device 110 may receive 245 the second mode indication from the second device 120. In response to the second mode indication, the first device 110 may determine a second barring configuration corresponding to the second ES mode from the at least one ES barring configuration. Then, the first device 110 may perform 250 a second access control related operation based on the second barring configuration. For example, the first device 110 may apply a cell barring indication corresponding to the second ES mode to determine whether to camp on a cell of the second device 120. Alternatively, or in addition, the first device 110 may apply access barring parameters corresponding to the second ES mode to perform an access barring check for an access attempt. The second access control related operation is similar to the first access control related operation as described with respect to 235 and thus is not repeated here.

In some example embodiments, if the second device 120 enters into the non-ES mode or is not operating in any ES mode, the second device 120 may transmit 255 to the first device 110 a third mode indication that the second device 110 operates in the non-ES mode. For example, if a switch from an ES mode to the non-ES mode, the second device 120 may indicate the first device 110 of the switch.

Accordingly, the first device 110 may receive 260 the third mode indication from the second device 120. In response to the third mode indication, the first device 110 may determine a third barring configuration corresponding to the non-ES mode. The third barring configuration may be the non-ES barring configuration transmitted along with the at least one ES barring configuration. Alternatively, the third barring configuration may be the legacy barring information for congestion.

Then, the first device 110 may perform 265 a third access control related operation based on the third barring configuration. For example, the first device 110 may apply a cell barring indication of the third barring configuration to determine whether to camp on a cell of the second device 120. Alternatively, or in addition, the first device 110 may apply access barring parameters of the third barring configuration to perform an access barring check for an access attempt to the second device 120.

Through the above discussion, access of the ES supporting devices (such as NES supporting UEs) to the second device (such as the gNB) can be controlled dynamically. Moreover, such dynamic control does not involve update of SIB, enabling flexible control.

In addition to the first device 110 which support ES mode of the second device 120, the second device 120 may handle configurations of the third device 130 which does not support the ES mode. In some example embodiments, if the second device 120 operates in an ES mode for which access barring is required, the second device 120 may adjust the legacy barring configuration to enable access barring for the third device 130, which is a legacy device.

Alternatively, in some example embodiments, if the second device 120 operates in an ES mode for which access barring is required, the second device 120 may configure the legacy cell barring indication “cellBarred” as barred to avoid the third device 130 to camp on the cell. In contrast, the first device 110 which can interpret the access barring configuration for the ES mode ignores the legacy cell barring indication “cellBarred”. Instead, the first device 110 may apply the access baring configuration (if configured) corresponding to the ES mode.

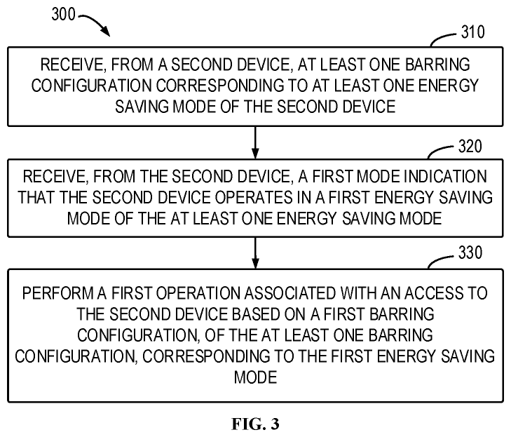

FIG. 3 shows a flowchart of an example method 300 implemented at a first device in accordance with some example embodiments of the present disclosure. For the purpose of discussion, the method 300 will be described from the perspective of the first device 110 in FIG. 1.

At block 310, the first device 110 receives, from a second device 120, at least one barring configuration corresponding to at least one energy saving mode of the second device 120. At block 320, the first device 110 receives, from the second device 120, a first mode indication that the second device 120 operates in a first energy saving mode of the at least one energy saving mode. At block 330, the first device 110 performs a first operation associated with an access to the second device 120 based on a first barring configuration, of the at least one barring configuration, corresponding to the first energy saving mode.

In some example embodiments, the method 300 further comprising: receiving, from the second device 120, a second mode indication that the second device 120 operates in a second energy saving mode of the at least one energy saving mode different from the first energy saving mode; and performing a second operation associated with an access to the second device 120 based on a second barring configuration, of the at least one barring configuration, corresponding to the second energy saving mode.

In some example embodiments, the method 300 further comprises: receiving, from the second device 120, a third mode indication that the second device 120 operates in a non-energy saving mode; and performing a third operation associated with an access to the second device 120 based on a third barring configuration corresponding to the non-energy saving mode.

In some example embodiments, the first barring configuration comprises a set of access barring parameters corresponding to the first energy saving mode, and performing the first operation comprises: performing access barring check for an access attempt to the second device 120 based on the set of access barring parameters.

In some example embodiments, performing the access barring check comprises: receiving, from the second device 120, first information indicating an association between the first energy saving mode and an access identity; and performing the access barring check for the access attempt associated with the access identity based on the set of access barring parameters.

In some example embodiments, performing the access barring check comprises: receiving, from the second device 120, second information indicating an association between the first energy saving mode and an access category; and performing the access barring check for the access attempt associated with the access category based on the set of access barring parameters.

In some example embodiments, the set of access barring parameters comprises at least one of: a barring indicator for the first energy saving mode, a barring factor for the first energy saving mode, a barring time for the first energy saving mode, or an indication of a barring timer for the first energy saving mode.

In some example embodiments, the method 300 further comprises: determining the set of access barring parameters from the at least one barring configuration based on the first energy saving mode and at least one of: a beam via which the first device 110 and second device 120 communicate, or a Public Land Mobile Network serving the first device 110.

In some example embodiments, the first barring configuration comprises a cell barring indication of whether a cell served by the second device 120 is barred for the first energy saving mode, and performing the first operation comprises: determining whether the cell is barred for the first energy saving mode based on the cell barring indication; in accordance with a determination that the cell is not barred for the first energy saving mode, camping on the cell for a subsequent access to the second device 120.

In some example embodiments, receiving the at least one barring configuration comprises at least one of: receiving at least a portion of the at least one barring configuration in an information block broadcast by the second device 120, or receiving at least a portion of the at least one barring configuration in a message dedicated to the first device 110 from the second device 120.

In some example embodiments, the method 300 further comprises: skipping applying a further barring configuration configured for a device not supporting the at least one energy saving mode of the second device 120. For example, the legacy barring configuration for the legacy UEs may be skipped by the first device 110.

In some example embodiments, skipping applying the further barring configuration is based on receiving the at least one barring configuration.

In some example embodiments, the method 300 further comprises: receiving, from the second device 120, an indication to skip applying a further barring configuration configured for a device not supporting the at least one energy saving mode of the second device 120; and skipping applying the further barring configuration based on receiving the indication.

In some example embodiments, the first device 110 comprises a terminal device and the second device 120 comprises a network device.

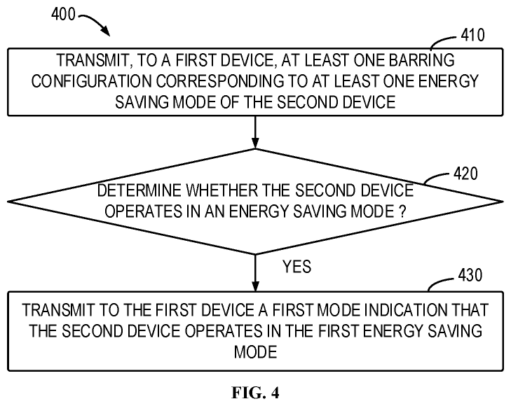

FIG. 4 shows a flowchart of an example method 400 implemented at a second device 120 in accordance with some example embodiments of the present disclosure. For the purpose of discussion, the method 400 will be described from the perspective of the second device 120 120 in FIG. 1.

At block 410, the second device 120 transmits, to a first device 110, at least one barring configuration corresponding to at least one energy saving mode of the second device 120. At block 420, the second device 120 determines whether the second device 120 operates in an energy saving mode of the at least one energy saving mode. If the second device 120 determines that the second device 120 operates in a first energy saving mode, the method 400 proceeds to block 430. At block 430, the second device 120 transmits to the first device 110 a first mode indication that the second device 120 operates in the first energy saving mode.

In some example embodiments, the method 400 further comprises: in accordance with a determination that the second device 120 operates in a second energy saving mode of the at least one energy saving mode different from the first energy saving mode, transmitting to the first device 110 a second mode indication that the second device 120 operates in the second energy saving mode.

In some example embodiments, the method 400 further comprises: in accordance with a determination that the second device 120 operates in a non-energy saving mode, transmitting to the first device 110 a third mode indication that the second device 120 operates in the non-energy saving mode.

In some example embodiments, a first barring configuration, of the at least one barring configuration, corresponding to the first energy saving mode comprises a set of access barring parameters corresponding to the first energy saving mode.

In some example embodiments, the method 400 further comprises: transmitting, to the first device 110, first information indicating an association between the first energy saving mode and an access identity, the access identity being associated with an access attempt by the first device 110 to the second device 120.

In some example embodiments, the method 400 further comprises: transmitting, to the first device 110, second information indicating an association between the first energy saving mode and an access category, the access category being associated with an access attempt by the first device 110 to the second device 120.

In some example embodiments, the set of access barring parameters comprises at least one of: a barring indicator for the first energy saving mode, a barring factor for the first energy saving mode, a barring time for the first energy saving mode, or an indication of a barring timer for the first energy saving mode.

In some example embodiments, a first barring configuration, of the at least one barring configuration, corresponding to the first energy saving mode comprises a cell barring indication of whether a cell served by the second device 120 is barred for the first energy saving mode.

In some example embodiments, transmitting the at least one barring configuration comprises at least one of: broadcasting at least a portion of the at least one barring configuration in an information block, or transmitting, to the first device 110, at least a portion of the at least one barring configuration in a message dedicated to the first device 110.

In some example embodiments, the method 400 further comprises: transmitting, to the first device 110, an indication to skip applying a further barring configuration configured for a device not supporting the at least one energy saving mode of the second device 120.

In some example embodiments, the first device 110 comprises a terminal device and the second device 120 comprises a network device.

In some example embodiments, a first apparatus capable of performing any of the method 300 (for example, the first device 110 in FIG. 1) may comprise means for performing the respective operations of the method 800. The means may be implemented in any suitable form. For example, the means may be implemented in a circuitry or software module. The first apparatus may be implemented as or included in the first device 110 in FIG. 1.

In some example embodiments, the first apparatus comprises: means for receiving, from a second apparatus, at least one barring configuration corresponding to at least one energy saving mode of the second apparatus; means for receiving, from the second apparatus, a first mode indication that the second apparatus operates in a first energy saving mode of the at least one energy saving mode; and means for performing a first operation associated with an access to the second apparatus based on a first barring configuration, of the at least one barring configuration, corresponding to the first energy saving mode.

In some example embodiments, the first apparatus further comprises: means for receiving, from the second apparatus, a second mode indication that the second apparatus operates in a second energy saving mode of the at least one energy saving mode different from the first energy saving mode; and means for performing a second operation associated with an access to the second apparatus based on a second barring configuration, of the at least one barring configuration, corresponding to the second energy saving mode.

In some example embodiments, the first apparatus further comprises: means for receiving, from the second apparatus, a third mode indication that the second apparatus operates in a non-energy saving mode; and means for performing a third operation associated with an access to the second apparatus based on a third barring configuration corresponding to the non-energy saving mode.

In some example embodiments, the first barring configuration comprises a set of access barring parameters corresponding to the first energy saving mode, and the means for performing the first operation comprises: means for performing access barring check for an access attempt to the second apparatus based on the set of access barring parameters.

In some example embodiments, the means for performing the access barring check comprises: means for receiving, from the second apparatus, first information indicating an association between the first energy saving mode and an access identity; and means for performing the access barring check for the access attempt associated with the access identity based on the set of access barring parameters.

In some example embodiments, the means for performing the access barring check comprises: means for receiving, from the second apparatus, second information indicating an association between the first energy saving mode and an access category; and means for performing the access barring check for the access attempt associated with the access category based on the set of access barring parameters.

In some example embodiments, the set of access barring parameters comprises at least one of: a barring indicator for the first energy saving mode, a barring factor for the first energy saving mode, a barring time for the first energy saving mode, or an indication of a barring timer for the first energy saving mode.

In some example embodiments, the first apparatus further comprises: means for determining the set of access barring parameters from the at least one barring configuration based on the first energy saving mode and at least one of: a beam via which the first and second apparatuses communicate, or a Public Land Mobile Network serving the first apparatus.

In some example embodiments, the first barring configuration comprises a cell barring indication of whether a cell served by the second apparatus is barred for the first energy saving mode, and the means for performing the first operation comprises: means for determining whether the cell is barred for the first energy saving mode based on the cell barring indication; means for in accordance with a determination that the cell is not barred for the first energy saving mode, camping on the cell for a subsequent access to the second apparatus.

In some example embodiments, the means for receiving the at least one barring configuration comprises at least one of: means for receiving at least a portion of the at least one barring configuration in an information block broadcast by the second apparatus, or means for receiving at least a portion of the at least one barring configuration in a message dedicated to the first apparatus from the second apparatus.

In some example embodiments, the first apparatus further comprises: means for skipping applying a further barring configuration configured for a device not supporting the at least one energy saving mode of the second device.

In some example embodiments, skipping applying the further barring configuration is based on receiving the at least one barring configuration.

In some example embodiments, the first apparatus further comprises: means for receiving, from the second apparatus, an indication to skip applying a further barring configuration configured for a device not supporting the at least one energy saving mode of the second device; and means for skipping applying the further barring configuration based on receiving the indication.

In some example embodiments, the first apparatus comprises a terminal device and the second apparatus comprises a network device.

In some example embodiments, the first apparatus further comprises means for performing other operations in some example embodiments of the method 800 or the first device 110. In some example embodiments, the means comprises at least one processor; and at least one memory storing instructions that, when executed by the at least one processor, cause the performance of the first apparatus.

In some example embodiments, a second apparatus capable of performing any of the method 400 (for example, the second device 120 in FIG. 1) may comprise means for performing the respective operations of the method 400. The means may be implemented in any suitable form. For example, the means may be implemented in a circuitry or software module. The second apparatus may be implemented as or included in the second device 120 in FIG. 1.

In some example embodiments, the second apparatus comprises means for transmitting, to a first apparatus, at least one barring configuration corresponding to at least one energy saving mode of the second apparatus; means for determining whether the second apparatus operates in an energy saving mode of the at least one energy saving mode; and means for in accordance with a determination that the second apparatus operates in a first energy saving mode of the at least one energy saving mode, transmitting to the first apparatus a first mode indication that the second apparatus operates in the first energy saving mode.

In some example embodiments, the second apparatus further comprises: means for in accordance with a determination that the second apparatus operates in a second energy saving mode of the at least one energy saving mode different from the first energy saving mode, transmitting to the first apparatus a second mode indication that the second apparatus operates in the second energy saving mode.

In some example embodiments, the second apparatus further comprises: means for in accordance with a determination that the second apparatus operates in a non-energy saving mode, transmitting to the first apparatus a third mode indication that the second apparatus operates in the non-energy saving mode.

In some example embodiments, a first barring configuration, of the at least one barring configuration, corresponding to the first energy saving mode comprises a set of access barring parameters corresponding to the first energy saving mode.

In some example embodiments, the second apparatus further comprises: means for transmitting, to the first apparatus, first information indicating an association between the first energy saving mode and an access identity, the access identity being associated with an access attempt by the first apparatus to the second apparatus.

In some example embodiments, the second apparatus further comprises: means for transmitting, to the first apparatus, second information indicating an association between the first energy saving mode and an access category, the access category being associated with an access attempt by the first apparatus to the second apparatus.

In some example embodiments, the set of access barring parameters comprises at least one of: a barring indicator for the first energy saving mode, a barring factor for the first energy saving mode, a barring time for the first energy saving mode, or an indication of a barring timer for the first energy saving mode.

In some example embodiments, a first barring configuration, of the at least one barring configuration, corresponding to the first energy saving mode comprises a cell barring indication of whether a cell served by the second apparatus is barred for the first energy saving mode.

In some example embodiments, the means for transmitting the at least one barring configuration comprises at least one of: means for broadcasting at least a portion of the at least one barring configuration in an information block, or means for transmitting, to the first apparatus, at least a portion of the at least one barring configuration in a message dedicated to the first apparatus.

In some example embodiments, the second apparatus further comprises: means for transmitting, to the first apparatus, an indication to skip applying a further barring configuration configured for a device not supporting the at least one energy saving mode of the second device.

In some example embodiments, the first apparatus comprises a terminal device and the second apparatus comprises a network device.

In some example embodiments, the second apparatus further comprises means for performing other operations in some example embodiments of the method 400 or the second device 120. In some example embodiments, the means comprises at least one processor; and at least one memory storing instructions that, when executed by the at least one processor, cause the performance of the second apparatus.

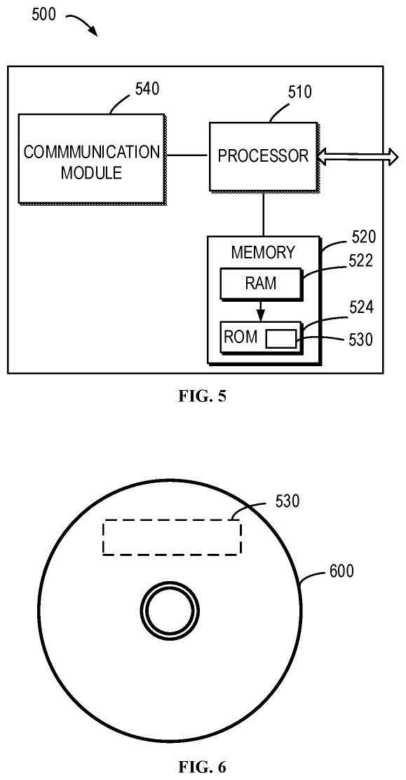

FIG. 5 is a simplified block diagram of a device 500 that is suitable for implementing example embodiments of the present disclosure. The device 500 may be provided to implement a communication device, for example, the first device 110 or the second device 120 as shown in FIG. 1. As shown, the device 500 includes one or more processors 510, one or more memories 520 coupled to the processor 510, and one or more communication modules 540 coupled to the processor 510.

The communication module 540 is for bidirectional communications. The communication module 540 has one or more communication interfaces to facilitate communication with one or more other modules or devices. The communication interfaces may represent any interface that is necessary for communication with other network elements. In some example embodiments, the communication module 540 may include at least one antenna.

The processor 510 may be of any type suitable to the local technical network and may include one or more of the following: general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

The memory 520 may include one or more non-volatile memories and one or more volatile memories. Examples of the non-volatile memories include, but are not limited to, a Read Only Memory (ROM) 524, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 522 and other volatile memories that will not last in the power-down duration.

A computer program 530 includes computer executable instructions that are executed by the associated processor 510. The instructions of the program 530 may include instructions for performing operations/acts of some example embodiments of the present disclosure. The program 530 may be stored in the memory, e.g., the ROM 524. The processor 510 may perform any suitable actions and processing by loading the program 530 into the RAM 522.

The example embodiments of the present disclosure may be implemented by means of the program 530 so that the device 500 may perform any process of the disclosure as discussed with reference to FIG. 2 to FIG. 4. The example embodiments of the present disclosure may also be implemented by hardware or by a combination of software and hardware.

In some example embodiments, the program 530 may be tangibly contained in a computer readable medium which may be included in the device 500 (such as in the memory 520) or other storage devices that are accessible by the device 500. The device 500 may load the program 530 from the computer readable medium to the RAM 522 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 6 shows an example of the computer readable medium 600 which may be in form of CD, DVD or other optical storage disk. The computer readable medium 600 has the program 530 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provides at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-30. (canceled)

31. A first apparatus comprising:
at least one processor; and
at least one memory storing instructions that, when executed by the at least one processor, cause the first device at least to perform:
receiving, from a second device, at least one barring configuration corresponding to at least one energy saving mode of the second device;
receiving, from the second device, a first mode indication that the second device operates in a first energy saving mode of the at least one energy saving mode; and
performing a first operation associated with an access to the second device based on a first barring configuration, of the at least one barring configuration, corresponding to the first energy saving mode.

32. The first device of claim 31, wherein the first device is further caused to perform:
receiving, from the second device, a second mode indication that the second device operates in a second energy saving mode of the at least one energy saving mode different from the first energy saving mode; and
performing a second operation associated with an access to the second device based on a second barring configuration, of the at least one barring configuration, corresponding to the second energy saving mode.

33. The first device of claim 31, wherein the first device is further caused to perform:
receiving, from the second device, a third mode indication that the second device operates in a non-energy saving mode; and
performing a third operation associated with an access to the second device based on a third barring configuration corresponding to the non-energy saving mode.

34. The first device of claim 31, wherein the first barring configuration comprises a set of access barring parameters corresponding to the first energy saving mode, and performing the first operation comprises:
performing access barring check for an access attempt to the second device based on the set of access barring parameters.

35. The first device of claim 34, wherein performing the access barring check comprises:
receiving, from the second device, first information indicating an association between the first energy saving mode and an access identity; and
performing the access barring check for the access attempt associated with the access identity based on the set of access barring parameters.

36. The first device of claim 34, wherein performing the access barring check comprises:
receiving, from the second device, second information indicating an association between the first energy saving mode and an access category; and
performing the access barring check for the access attempt associated with the access category based on the set of access barring parameters.

37. The first device of claim 34, wherein the set of access barring parameters comprises at least one of:
a barring indicator for the first energy saving mode,
a barring factor for the first energy saving mode,
a barring time for the first energy saving mode, or
an indication of a barring timer for the first energy saving mode.

38. The first device of claim 34, wherein the first device is further caused to perform:
determining the set of access barring parameters from the at least one barring configuration based on the first energy saving mode and at least one of:
a beam via which the first and second devices communicate, or
a Public Land Mobile Network serving the first device.

39. The first device of claim 31, wherein the first barring configuration comprises a cell barring indication of whether a cell served by the second device is barred for the first energy saving mode, and performing the first operation comprises:
determining whether the cell is barred for the first energy saving mode based on the cell barring indication;
in accordance with a determination that the cell is not barred for the first energy saving mode, camping on the cell for a subsequent access to the second device.

40. The first device of claim 31, wherein receiving the at least one barring configuration comprises at least one of:
receiving at least a portion of the at least one barring configuration in an information block broadcast by the second device, or
receiving at least a portion of the at least one barring configuration in a message dedicated to the first device from the second device.

41. The first device of claim 31, wherein the first device is further caused to perform:
skipping applying a further barring configuration configured for a device not supporting the at least one energy saving mode of the second device.

42. The first device of claim 41, wherein skipping applying the further barring configuration is based on receiving the at least one barring configuration.

43. The first device of claim 31, wherein the first device is further caused to perform:
receiving, from the second device, an indication to skip applying a further barring configuration configured for a device not supporting the at least one energy saving mode of the second device; and
skipping applying the further barring configuration based on receiving the indication.

44. The first device of claim 31, wherein the first device comprises a terminal device and the second device comprises a network device.

45. A second device comprising:
at least one processor; and
at least one memory storing instructions that, when executed by the at least one processor, cause the second device at least to perform:
transmitting, to a first device, at least one barring configuration corresponding to at least one energy saving mode of the second device;
determining whether the second device operates in an energy saving mode of the at least one energy saving mode; and
in accordance with a determination that the second device operates in a first energy saving mode of the at least one energy saving mode, transmitting to the first device a first mode indication that the second device operates in the first energy saving mode.

46. The second device of claim 45, wherein the second device is further caused to perform:
in accordance with a determination that the second device operates in a second energy saving mode of the at least one energy saving mode different from the first energy saving mode, transmitting to the first device a second mode indication that the second device operates in the second energy saving mode.

47. The second device of claim 45, wherein a first barring configuration, of the at least one barring configuration, corresponding to the first energy saving mode comprises a set of access barring parameters corresponding to the first energy saving mode.

48. The second device of claim 45, wherein a first barring configuration, of the at least one barring configuration, corresponding to the first energy saving mode comprises a cell barring indication of whether a cell served by the second device is barred for the first energy saving mode.

49. The second device of claim 45, wherein transmitting the at least one barring configuration comprises at least one of:
broadcasting at least a portion of the at least one barring configuration in an information block, or
transmitting, to the first device, at least a portion of the at least one barring configuration in a message dedicated to the first device.

50. A method comprising:
receiving, at a first device from a second device, at least one barring configuration corresponding to at least one energy saving mode of the second device;
receiving, from the second device, a first mode indication that the second device operates in a first energy saving mode of the at least one energy saving mode; and
performing a first operation associated with an access to the second device based on a first barring configuration, of the at least one barring configuration, corresponding to the first energy saving mode.
